(19) United States
(12) Patent Application Publication
(10) Pub. No.: US 2007/0178959 A1
(43) Pub. Date: Aug. 2, 2007

(54) Gaming machine having gameplay sequence designators

(75) Inventor: James Halprin, Balmain (AU)

Correspondence Address: NIXON PEABODY LLP, 161 N CLARK ST., 48TH FLOOR, CHICAGO, IL, 60601-3213, US

(73) Assignee: WMS Gaming Inc.

(21) Appl. No.: 11/342,411

(22) Filed: Jan. 30, 2006

(51) Int. Cl. A63F 13/00

(52) U.S. Cl. 463/20

(57) ABSTRACT

A gaming machine for conducting a wagering game includes a value input device for receiving a wager and a display for displaying a plurality of symbols arranged on a plurality of reels. The gaming machine further comprises a controller operative to spin the reels, sequentially stop the plurality of reels in a predetermined order, and cause the display to display a visual designation indicating the next reel in the sequence to be stopped. In one embodiment, the visual designation comprises an animated reel bezel surrounding the next reel in the sequence to be stopped.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to a gaming machine having one or more gameplay sequence designators.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

As gaming machine manufacturers seek to improve the entertainment provided by gaming machines, the games played thereon have become more advanced and sometimes complicated and more difficult to understand. Some game improvements have lengthened game play of a single game and added more elements to the display of the game. One problem that exists is that often a player's attention may not be focused on the portion of the game sequence which is about to occur, thereby depriving a player of full enjoyment of the entertainment and excitement which the game was designed to provide. The present invention is directed to solving these and other problems.

### SUMMARY OF THE INVENTION

According to one aspect of the present invention, a gaming machine for conducting a wagering game includes a value input device for receiving a wager and a display for displaying a plurality of symbols arranged on a plurality of reels. The gaming machine further comprises a controller operative to spin the reels, sequentially stop the plurality of reels in a predetermined order, and cause the display to display a visual designation indicating the next reel in the sequence to be stopped.

According to another aspect of the invention, a gaming machine for conducting a wagering game comprises a value input device for receiving a wager and a display for displaying a plurality of symbols arranged on a plurality of reels. The gaming machine further comprises a controller operative to spin the reels for a predetermined time, sequentially stop the plurality of reels in a predetermined order, and activate a designator to designate at least one of the reels in the sequence.

According to another aspect of the invention, a method of conducting a wagering game on a gaming machine comprises receiving a wager and displaying a plurality of symbols arranged on a plurality of reels. The method further includes spinning the plurality of reels in a predetermined order for a predetermined time, stopping each of the reels, and activating a designator to designate at least one of the reels before all of the reels have been stopped.

According to yet another aspect of the invention, a computer readable storage medium is encoded with instructions for directing a gaming device to perform the above method.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a gaming machine embodying the present invention;

FIG. 2 is a block diagram of a control system suitable for operating the gaming machine;

FIG. 3 is a front view of the display of the gaming machine depicting the commencement of a play of the game;

FIG. 4 is a front view of the display of the gaming machine depicting further progression of gameplay;

FIG. 5 is a front view of the display of the gaming machine depicting yet further progression of gameplay; and

FIG. 6 is a front view of the display of the gaming machine depicting yet further progression of gameplay.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

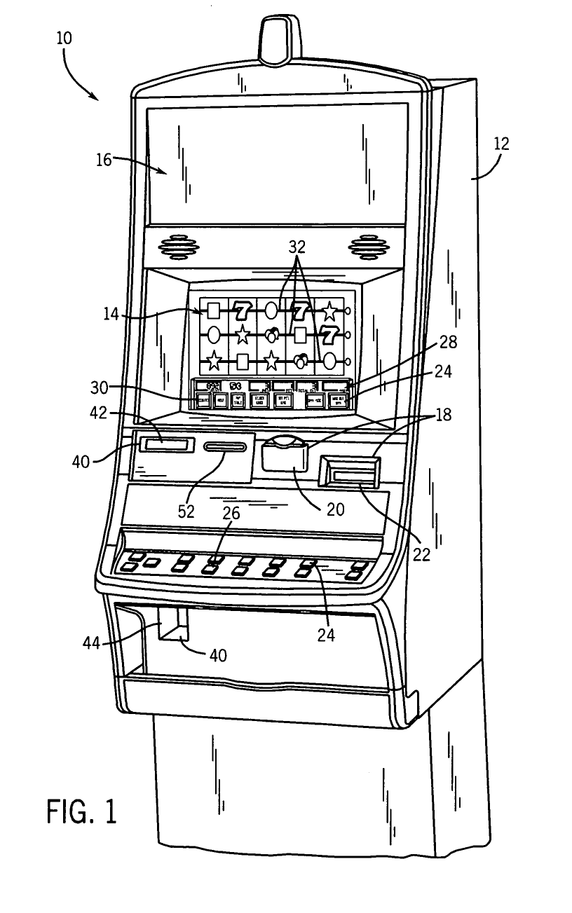

Referring to FIG. 1, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire monitor (or a portion thereof) to allow players to make game-related selections. Alternatively, the primary display 14 of the gaming machine 10 may include a number of mechanical reels to display the outcome in visual association with at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1 as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

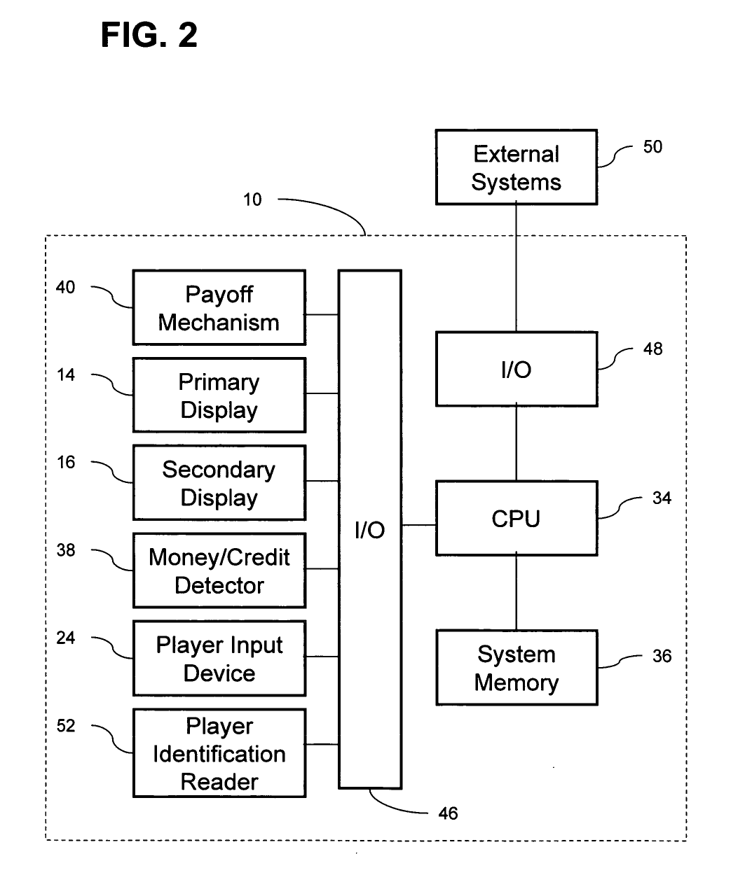

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36.

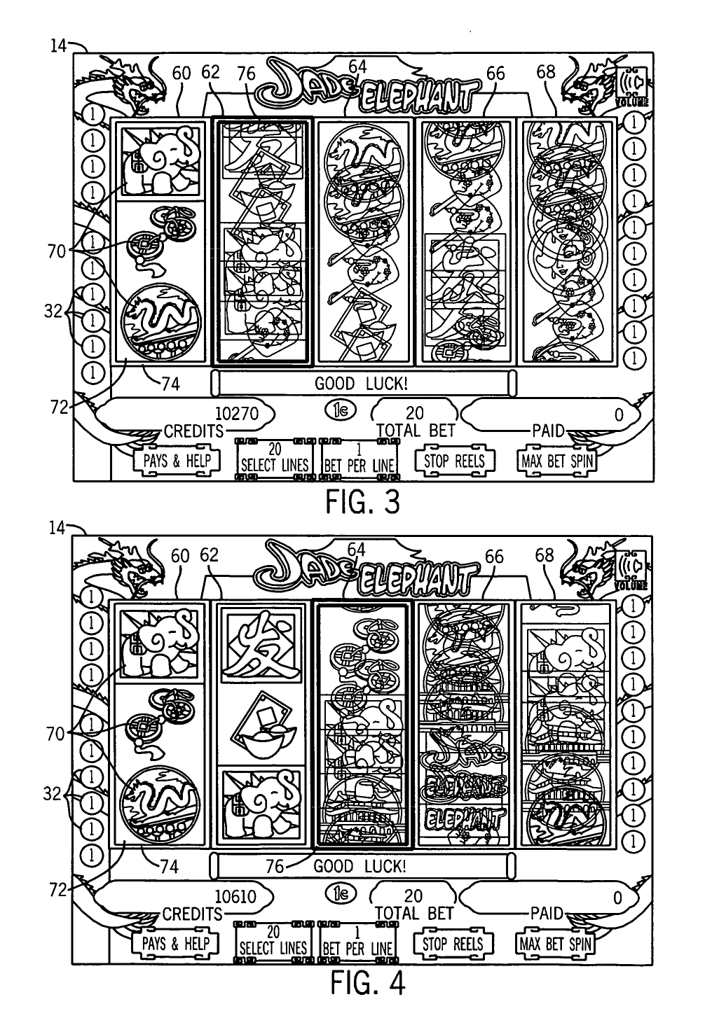

Turning now to FIG. 3, the primary display 14 of the gaming machine 10 is depicted showing a slot reel game played on the gaming machine 10. The display 14 includes a plurality of reels 60,62,64,66,68. Each of the 60,62,64,66,68 includes a plurality of symbols 70. The reels 60,62,64,66,68 may either be mechanical rotatable reels with the symbols 70 arranged around the periphery thereof, or as seen in FIG. 3, the reels 60,62,64,66,68 may be video simulations of rotatable mechanical reels. Each of the reels 60,62,64,66,68 is viewable through a reel window 72. The reel windows 72 are bordered and surrounded by a reel bezel 74. One or more paylines 32 pass through the symbols 70 upon which winning combinations are designated in accordance with a paytable of the gaming machine 10.

The bezels 74 surrounding the reels 60,62,64,66,68 include illumination, backlighting, or highlighting so that the bezels 74 may be controlled by the gaming machine 10 so as to light up. By lighting up one or more of the bezels 74, the gaming machine 10 may indicate information about the reels 60,62,64,66,68. In this way, the lighted bezel 74 acts as a designator 76 of one or more reels 60,62,64,66,68. For example, in FIG. 3, the bezel 74 around the second reel 62 is lit so as to designate the second reel 62, while the other bezels 74 around the remaining reels 60,64,66,68 are not lit. In this way, the second reel 62 is designated relative to the other reels 60,64,66,68. The designator 76 may be a backlit or illuminated bezel 74, or may include an animated border such that one or more animated elements are displayed about the bezel 74. Thus, the video display 14 may alter the bezel 74 from a plain border to an animation to create the designator 76. For example, the ordinarily static bezel 74 may be animated to become a border of flames, fire, or other animation so as to serve as a designator 76 of the reel. The animation may be generic or may be related to a theme of the gaming machine. For example, in the “Jade Elephant” game shown in FIG. 3, the designator 76 may be a green colored animation of the bezel 74 thereby relating to the “Jade” theme. Many other animations on the bezels 74 are possible to serve as designators 76.

During a single play of the slot reel game, as seen in FIG. 3, the reels 60,62,64,66,68 are spun and stopped to reveal a plurality of symbols 70 which are evaluated for winning combinations stopping on the one or more paylines 32. Preferably, the reels 60,62,64,66,68 are stopped in a predetermined order. In the embodiment shown in FIG. 3, the reels 60,62,64,66,68 are stopped in order from left to right, with a small delay between each reel stopping. Preferably, each reel 60,62,64,66,68 is spun for a predetermined, relatively short standard spin time before it is stopped. Thus, the first reel 60 has stopped to display three symbols 70, while the second, third, fourth and fifth reels 62,64,66,68 continue to spin. In this embodiment, the designator 76 is the highlighted bezel 74 which designates the second reel 62. Although the designator 76 may be used to designate a variety of information about the reels 60,62,64,66,68, in this embodiment, the designator 76 designates the next reel 62 to stop in the sequence of stopping reels. Thus, since the second reel 62 is spinning and is next to stop in the sequence, the designator 76 designates the second reel 62 by highlighting the bezel 74 around the reel 62.

Turning to FIG. 4, the first and second reels 60,62 have stopped while the remaining three reels 64,66,68 continue to spin. Because the third reel 64 is the next in the sequence to be stopped, the designator 76 designates the third reel 64 by highlighting the bezel 74 thereof. Also seen in FIG. 4, two “elephant” symbols 70 have landed on a payline 32 on the first two reels 60,62. Because three or more “elephant” symbols constitute a winning combination according to the paytable, the designator 76 highlighting the third reel 64 also designates the possibility of a “3-elephant” winning combination. Although the designators 76 may be used on every reel 60,62,64,66,68 to designate which reel is next to be stopped, in an alternative embodiment, the designators 76 only designate a reel 60,62,64,66,68 if it may potentially complete a predetermined combination (e.g., winning combination) when it stops, as seen in FIG. 4. Thus, in the alternative embodiment, the first and second reels 60,62 would not be designated but once two “elephant” symbols appeared, thereby making the third reel 64 eligible to complete the “3-elephant” combination, the designator 76 designates the third reel 64. Moreover, if two “elephant” symbols are displayed on the first two reels 60,62 indicating a partial winning combination, then in addition to the designator 76 designating the third reel 64, the time that the third reel 64 remains spinning may be increased from a standard spin time to an extended spin time, thus adding to the suspense and anticipation. Thus, the designator 76 may also designate a particular reel 60,62,64,66,68 by extending the reel spin by increasing the time the reel is spun. The designator 76 may also vary the speed of the reel spin during the extended spin for even more dramatic anticipation effect. Thus, in addition to extending the reel spin time from a standard spin time to an extended spin time, the designator 76 may slow the reel down or speed the reel up during the extended spin time, coming to an eventual stop to highlight its importance as potentially completing a winning combination.

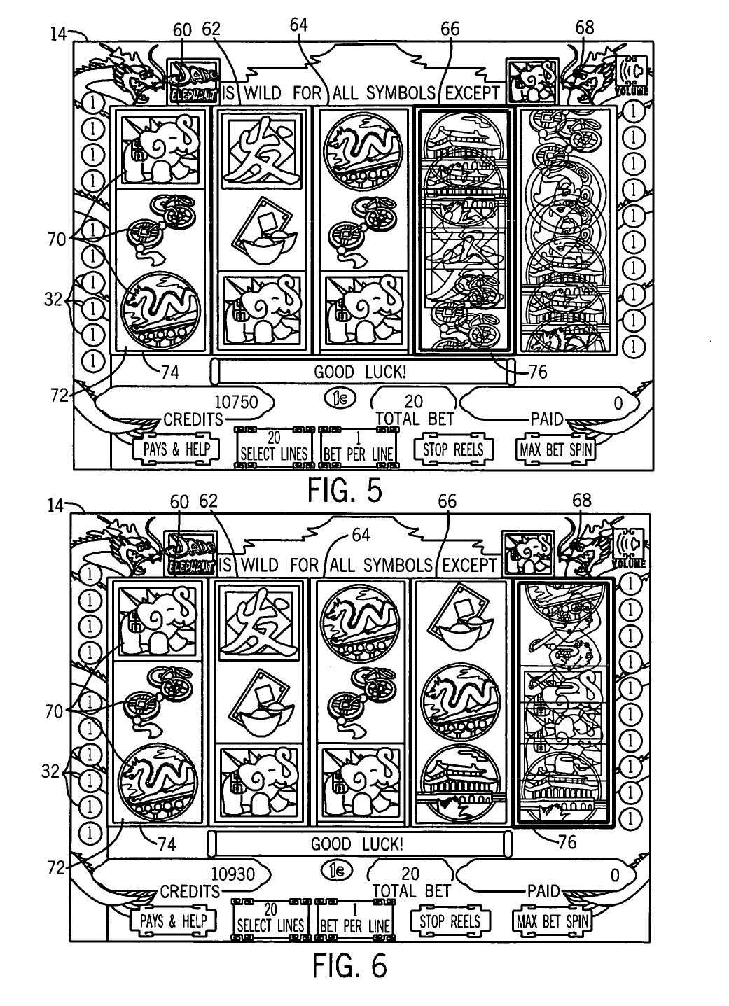

Turning to FIG. 5, the first three reels 60,62,64 have stopped while the fourth and fifth reels 66,68 continue to spin. The designator 76 designates the fourth reel 66 as being the next reel in the sequence to be stopped by highlighting the bezel 74 thereof. Since the first three reels 60,62,64 indicate a “3-elephant” combination, the play of the game will result in at least that winning combination being awarded. However, since the fourth and fifth reels 66,68 remain spinning, the “3-elephant” combination may be improved to a “4-elephant” or “5-elephant” winning combination. Moreover, other wins may occur which did not occur on the first three reels 60,62,64. In FIG. 6, the first four reels 60,62,64,66 have stopped and only the fifth reel 68 remains spinning. It is designated by the designator 76 as being the next reel 68, and in this case the final reel, in the sequence to be stopped. The designator 76 highlights the bezel 74 to designate the fifth reel 68.

In an alternative embodiment, the designator 76 designates reels 60,62,64,66,68 which have already been stopped rather than those which remain spinning. In such an embodiment, the designated stopped reels 60,62,64,66,68 are designated to indicate that the reels have stopped and that the symbols 70 thereon may be part of a predetermined combination (e.g., winning combination). Alternatively, the designator 76 may only designated stopped reels 60,62,64,66,68 if those reels include a portion of a predetermined combination (e.g., winning combination). For example, if the first two reels 60,62 have stopped and include two “elephant” symbols 70 on an active payline 32, then the designator 76 may designate the first two reels 60,62 by highlighting the bezels 74 thereof so as to indicate that one more “elephant” symbol on any of the remaining three reels 64,66,68 will complete the “3-elephant” winning combination. In this way, the designator 76 is used to add suspense and anticipation to gameplay by designating potential winning combinations when partial winning combinations have been achieved.

In other alternative embodiments, the designator 76, in addition to the highlighted, backlit, or animated bezels 74, may include other video displays or audio indicators. For example, the designator 76 may include audio indicators as well as visual indicators. By increasing the volume of the audio of the gaming machine 10, for example, the designator 76 may increase suspense and anticipation of game play. Moreover, any number of video displays may be used in addition to or instead of the bezel 74 highlighting and animation to comprise the designator 76. Furthermore, in addition to the designator 76 utilizing the bezel 74 of the reel 60,62,64,66,68 for designation, the designator 76 may alternatively or in addition use the background of the reel viewable through the reel window 72 to designate the reel 60,62,64,66,68. For example, the background of the reel 60,62,64,66,68 may be changed in color, animated, highlighted, or otherwise altered to designate the reel 60,62,64,66,68. All that is preferred is that the designator 76 designate the sequence of game play by either indicated reels 60,62,64,66,68 that have stopped or reels 60,62,64,66,68 that are next to be stopped.

A number of other alternate components may comprise the designator 76 so as to designate a particular reel 60,62,64,66,68. For example, the designator 76 may include expanding or shrinking the size of the reel 60,62,64,66,68 so as to designate the reel 60,62,64,66,68 in the sequence. The designator 76 may shake, bounce, vibrate, translate, rotate, or otherwise move a reel 60,62,64,66,68 in the sequence to designate that reel. Alternatively, the designator 76 may reverse or change the direction of spin of a reel 60,62,64,66,68. Many other possibilities of designators 76 exist so as to distinguish one reel over another, thereby designating the reel.

Moreover, although in the embodiments described herein and depicted in the FIGS. the game is a slot reel game, the designators 76 may be used with many varieties of game play on the gaming machine 10. For example, the gaming machine may play video poker, black jack, roulette, bingo, keno, or any number of other basic or bonus games. The designator 76 may be used within those alternate games to designate dice, cards, balls, or other game elements and the sequence of game play thereof. The designator 76 may include a highlighted or animated bezel 74 about the game element, or may include other video displays such as arrows, shadowing, highlights, etc.

The designators 76 of the present invention provide a number of advantages to improve the entertainment and enjoyability of the gaming machine 10. By designating the order or sequence of game play, the designator 76 assists in focusing the player's attention on the appropriate portion of the display 14 at the appropriate time during the game, thereby improving the player's understanding of the gaming machine 10. Moreover, by designating potential winning outcomes the designator 76 improves the excitement and anticipation of the game by increasing anticipation and excitement of the gaming machine 10 at appropriate times when a winning outcome may be achieved.

Each of these embodiments and obvious variations thereof is contemplated as falling within the spirit and scope of the claimed invention, which is set forth in the following claims.

What is claimed is:

1. A gaming machine comprising:
a value input device for receiving a wager;
a display for displaying a plurality of symbols arranged on a plurality of reels,
a controller operative to:
spin the reels;
sequentially stop the plurality of reels in a predetermined order; and
cause the display to display a visual designation indicating the next reel in the sequence to be stopped.

2. The gaming machine of claim 1, wherein the controller is further operative to cause the display to remove the designation from a stopped reel.

3. The gaming machine of claim 1, wherein the visual designation includes a bezel positioned around the reel.

4. The gaming machine of claim 3, wherein the bezel is highlighted, backlit or animated during the visual designation.

5. The gaming machine of claim 1, wherein the visual designation comprises highlighting the reel.

6. The gaming machine of claim 1, wherein the controller is further operative to increase the length of time which a visually designated reel spins from a standard spin time to an extended spin time.

7. A gaming machine comprising:
a value input device for receiving a wager;
a display for displaying a plurality of symbols arranged on a plurality of reels,
a controller operative to:
spin the reels for a predetermined time;
sequentially stop the plurality of reels in a predetermined order; and
activate a designator to designate at least one of the reels in the sequence.

8. The gaming machine of claim 7, wherein the designator comprises animating a bezel surround the at least one reel.

9. The gaming machine of claim 8, wherein the controller is further operative to extend the spin of the at least one reel from a standard spin time to an extended spin time.

10. The gaming machine of claim 7, wherein the designator designates the next reel in the sequence to be stopped.

11. The gaming machine of claim 7, wherein the designator designates at least one stopped reel.

12. The gaming machine of claim 11, wherein the at least one stopped reel indicates at least a portion of a winning combination.

13. The gaming machine of claim 7, wherein the designator includes an audio output or a modified audio output.

14. A method of conducting a wagering game on a gaming machine, the method comprising:
receiving a wager;
displaying a plurality of symbols arranged on a plurality of reels,
spinning the plurality of reels in a predetermined order for a predetermined time;
stopping each of the reels; and
activating a designator to designate at least one of the reels before all of the reels have been stopped.

15. The method of claim 14, wherein activating the designator comprises animating a bezel around the at least one reel.

16. The method of claim 15, wherein activating the designator further comprises extending the spin of the at least one reel from a standard spin time to an extended spin time.

17. The method of claim 14, wherein the designator further comprises an audio output or a modified audio output.

18. The method of claim 14, wherein the designator designates the next reel to be stopped.

19. The method of claim 14, wherein the designator designates a stopped reel.

20. A computer readable storage medium encoded with instructions for directing a gaming device to perform the method of claim 14.
